(19) United States
(12) Patent Application Publication
(10) Pub. No.: US 2022/0385636 A1
(43) Pub. Date: Dec. 1, 2022

(54) METHOD AND DEVICE FOR PROCESSING DATA ASSOCIATED WITH A FIRST NETWORK ELEMENT

(71) Applicant: Robert Bosch GmbH, Stuttgart (DE)

(72) Inventors: Andreas Weber, Weissach (DE); Janin Wolfinger, Birkenfeld (DE); Jens Gramm, Tuebingen (DE); Tobias Rudolph, Leinfelden (DE)

(21) Appl. No.: 17/746,123

(22) Filed: May 17, 2022

(30) Foreign Application Priority Data
May 27, 2021 (DE) 10 2021 205 418.8

(51) Int. Cl. H04L 9/40; H04L 41/0604

(52) U.S. Cl. CPC H04L 63/0263; H04L 41/0604

(57) ABSTRACT

A computer-implemented method for processing data associated with a first network element. The method includes: ascertaining a subset of a data traffic associated with the network element, and evaluating the subset.

### FIELD

The present invention relates to a method for processing data associated with a first network element.

The present invention furthermore relates to a device for processing data associated with a first network element.

### SUMMARY

Exemplary specific embodiments of the present invention relate to a method, for example a computer-implemented method, for processing data associated with a first network element, including: ascertaining a subset of a data traffic associated with the network element, and evaluating the subset.

In further exemplary specific embodiments of the present invention, it is provided that the first network element is designed for coupling multiple further network elements, the first network element being a switch, for example.

In further exemplary specific embodiments of the present invention, it is provided that the ascertainment of the subset includes: selecting the subset based on a situation, the situation, for example, being characterizable and/or characterized by at least one of the following elements: a) state of a target system, for example of a device carrying out the method or at least portions of the method, for example of a vehicle, for example a motor vehicle; b) state of an attack recognition system, for example of an intrusion detection system, for example based on at least one, for example present, event of the attack recognition system, and/or based on a recognition of anomalies; c) state of a communication between sub-systems, for example of the target system, at least one sub-system including, e.g., a control unit or a sub-network of a network; d) state of surroundings; and e) state of at least one sub-system, for example of the target system, for example of the vehicle.

In further exemplary specific embodiments of the present invention, it is provided that the method includes at least one of the following elements: a) ascertaining the situation and/or at least one of the states based on the data traffic; b) receiving first pieces of information characterizing the situation and/or the at least one state, for example from at least one further unit.

In further exemplary specific embodiments of the present invention, it is provided that the method includes at least one of the following elements: filtering the data traffic, for example with the aid of a hardware-based filter device, the hardware-based filter device including at least one associative memory, for example a content-addressable memory, for example a ternary content-addressable memory (TCAM).

In further exemplary specific embodiments of the present invention, it is provided that the method includes: configuring and/or reconfiguring filter rules, for example for the ascertainment of the subset, for example with the aid of filtering, for example, the configuration and/or reconfiguration of the filter rules being repeated, for example periodically, and/or being carried out in an event-controlled manner.

In further exemplary specific embodiments of the present invention, it is provided that the configuration and/or reconfiguration of the filter rules is/are carried out dynamically, for example during the run time or during an operation of a device carrying out the method.

In further exemplary specific embodiments of the present invention, it is provided that the data traffic which does not belong to the subset is not evaluated and/or is disregarded during the evaluation.

In further exemplary specific embodiments of the present invention, it is provided that the method includes: using various hardware rule sets, for example filter rules, for example for a hardware-based filtering of the data traffic, for example for ascertaining the subset, and, optionally, loading the various hardware rule sets, for example according to a predefinable plan, for example characterizable by a predefinable planning algorithm, for example a scheduling algorithm.

In further exemplary specific embodiments of the present invention, it is provided that the method includes using at least one of the following elements for the planning algorithm: a) time-based execution, for example loading, a next hardware rule set being loaded and/or used, for example, after a predefinable first time; b) priority-based execution, a priority, for example, being assigned in each case to multiple rule sets, and, for example, a rule set having a higher priority being loaded and/or used more frequently than a rule set having a lower priority; c) port-based execution, a certain rule set, for example, being active at a port of the network element at any point in time, the rule sets for the port being changed, for example, after a predefinable time; d) execution based on a method according to the game theory, for example security games; e) execution, for example loading, based on a state machine, sequences in the data traffic, for example, triggering a reconfiguration of a rule set; f) event-based execution, for example, loading, the arrival of a predefinable packet of the data traffic, for example, triggering a reconfiguration of a rule set; and g) execution, for example loading, based on a packet number, a rule set being changed, for example, following a predefinable number of, e.g., examined, packets.

In further exemplary specific embodiments of the present invention, it is provided that the method includes: at least temporarily storing various hardware rule sets or the various hardware rule sets, and, optionally, loading and/or using at least one of the various hardware rule sets, for example according to a or the planning algorithm.

In further exemplary specific embodiments of the present invention, it is provided that the method includes at least one of the following elements: a) assigning at least one first rule set to a first operating state or a first situation, for example of a target system; b) assigning at least one second rule set to a second operating state or a second situation, for example of a or the target system; c) using the first rule set for the first operating state or the first situation; and d) using the second rule set for the second operating state or the second situation.

In further exemplary specific embodiments of the present invention, it is provided that the situation and/or the operating state include(s) at least one of the following elements: a) diagnosis; b) update; c) energy mode, e.g., power mode, e.g., energy-saving mode, e.g., low power mode, e.g., sleep state; d) drive modes, e.g., forward, gear, backward, etc.; e) modes such as sports mode, ECO, comfort, emergency running, etc.; f) seasons; g) weather conditions; h) road conditions; i) presence of a trailer load, e.g., trailer attached; and j) smart phone connected.

Further exemplary specific embodiments of the present invention relate to a device for carrying out the method according to the specific embodiments.

In further exemplary specific embodiments of the present invention, it is provided that the device includes: a computing unit (“computer”) including, e.g., at least one computing core, a memory unit assigned to the computing unit for at least temporarily storing at least one of the following elements: a) data; and b) computer program, in particular, for carrying out the method according to the specific embodiments.

In further exemplary specific embodiments of the present invention, the data may at least temporarily include the subset of the data traffic and/or data derivable therefrom, for example with the aid of the evaluation.

In further exemplary specific embodiments of the present invention, the memory unit includes a volatile memory (e.g., a working memory (RAM)), and/or a non-volatile memory (e.g., a Flash EEPROM), or a combination thereof or with other not explicitly described memory types.

Further exemplary specific embodiments of the present invention relate to a computer-readable memory medium, encompassing commands, which, during the execution by a computer, prompt the computer to carry out the method according to the specific embodiments.

Further exemplary specific embodiments of the present invention relate to a computer program, encompassing commands which, during the execution of the program by a computer, prompt the computer to carry out the method according to the specific embodiments.

Further exemplary specific embodiments of the present invention relate to a data medium signal which transfers and/or characterizes the computer program according to the specific embodiments.

Further exemplary specific embodiments of the present invention relate to a use of the method according to the specific embodiments and/or of the device according to the specific embodiments and/or of the computer-readable memory medium according to the specific embodiments and/or of the computer program according to the specific embodiments and/or of the data medium signal according to the specific embodiments for at least one of the following elements: a) ascertaining a subset of a data traffic associated with the network element, for example of a motor vehicle; b) evaluating a subset of a data traffic associated with the network element, for example of a motor vehicle; c) implementing a, for example network-based, attack recognition system (NIDS), for example for a motor vehicle, for example on a computing unit of a switch, for example an automotive switch; d) taking into consideration a portion of the data traffic associated with a situation and/or an operating state; e) configuring or reconfiguring, as a function of the situation, at least one aspect of a device carrying out the method, for example filter rules and/or rule sets, for example hardware rule sets.

Additional features, application options and advantages of the present invention are derived from the following description of exemplary embodiments of the present invention, which are shown in the figures. All described or illustrated features, either alone or in any arbitrary combination, form the subject matter of the present invention, regardless of the wording or representation thereof in the description or in the figures.

### BRIEF DESCRIPTION OF THE DRAWINGS

FIG. 1 schematically shows a simplified block diagram according to exemplary specific embodiments of the present invention.

FIG. 2 schematically shows a simplified flowchart according to exemplary specific embodiments of the present invention.

FIG. 3 schematically shows a simplified flowchart according to exemplary specific embodiments of the present invention.

FIG. 4 schematically shows a simplified block diagram according to exemplary specific embodiments of the present invention.

FIG. 5 schematically shows a simplified flowchart according to exemplary specific embodiments of the present invention.

FIG. 6 schematically shows a simplified flowchart according to exemplary specific embodiments of the present invention.

FIG. 7 schematically shows a simplified flowchart according to exemplary specific embodiments of the present invention.

FIG. 8 schematically shows a simplified diagram according to exemplary specific embodiments of the present invention.

FIG. 9 schematically shows a simplified flowchart according to exemplary specific embodiments of the present invention.

FIG. 10 schematically shows a simplified flowchart according to exemplary specific embodiments of the present invention.

FIG. 11 schematically shows a simplified flowchart according to exemplary specific embodiments of the present invention.

FIG. 12 schematically shows a simplified block diagram according to exemplary specific embodiments of the present invention.

FIG. 13 schematically shows aspects of uses according to further exemplary specific embodiments of the present invention.

### DETAILED DESCRIPTION OF EXAMPLE EMBODIMENTS

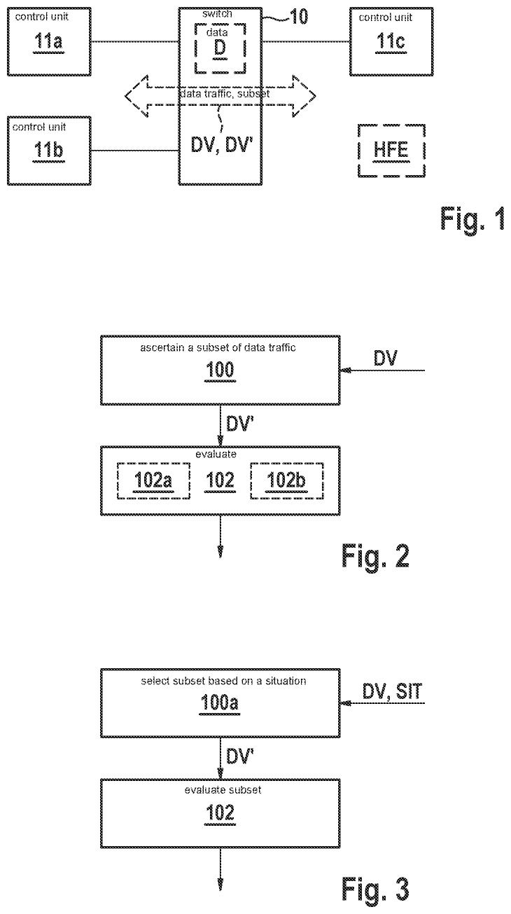

Exemplary specific embodiments, FIGS. 1 and 2, relate to a method, for example a computer-implemented method, for processing data D associated with a first network element 10, including: ascertaining 100 a subset DV′ of a data traffic DV associated with network element 10, and evaluating 102 subset DV′.

In further exemplary specific embodiments, it is provided that first network element 10 is designed for coupling multiple further network elements 11a, 11b, 11c, first network element 10, for example, being a switch, e.g., for automotive applications, for example for motor vehicles.

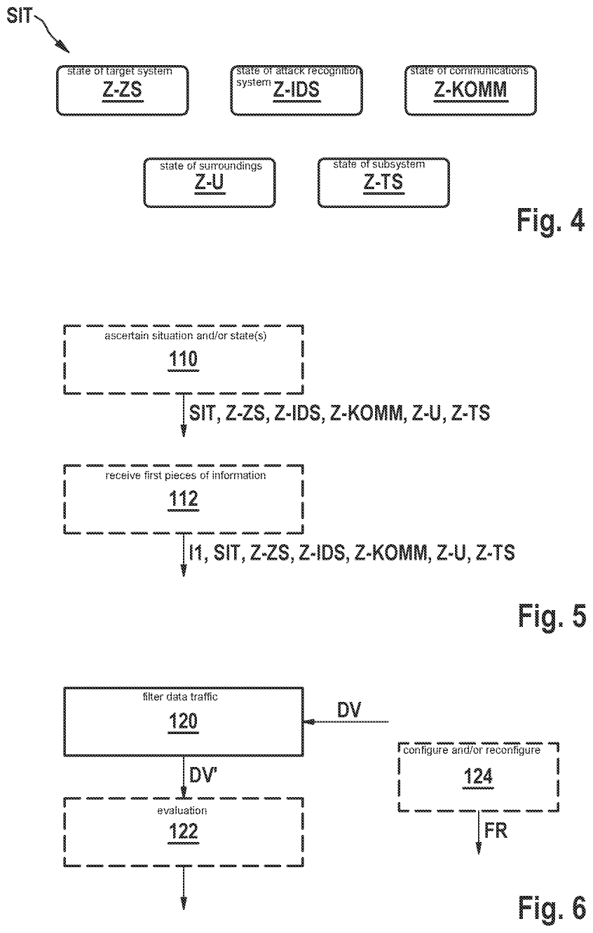

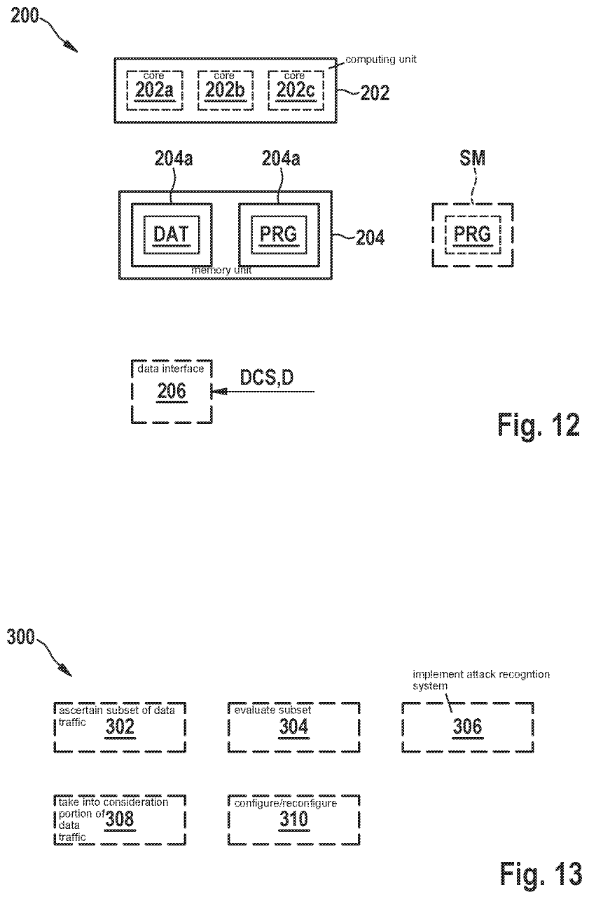

In further exemplary specific embodiments, FIG. 3, it is provided that ascertainment 100 of subset DV′ includes: selecting 100a subset DV′ based on a situation SIT, situation SIT, for example, being characterizable and/or characterized by at least one of the following elements, cf. FIG. 4: a) state Z-ZS of a target system, for example of a device 200 carrying out the method or at least portions of the method (FIG. 12), for example of a vehicle, for example a motor vehicle; b) state Z-IDS of an attack recognition system, for example of an intrusion detection system, for example based on at least one, for example present, event of the attack recognition system, and/or based on a recognition of anomalies; c) state Z-KOMM of a communication between sub-systems, for example of the target system, at least one sub-system including, e.g., a control unit 11a or a sub-network of a network; d) state Z-U of surroundings; and e) state Z-TS of at least one sub-system, for example of the target system, for example of the vehicle.

In further exemplary specific embodiments, FIG. 5, it is provided that the method includes at least one of the following elements: a) ascertaining 110 situation SIT and/or at least one of states Z-ZS, Z-IDS, Z-KOMM, Z-U, Z-TS based on data traffic DV; b) receiving 112 first pieces of information I1 characterizing situation SIT and/or the at least one state Z-ZS, Z-IDS, Z-KOMM, Z-U, Z-TS, for example from at least one further unit 11a (FIG. 1).

In further exemplary specific embodiments, FIG. 6, it is provided that the method includes at least one of the following elements: filtering 120 data traffic DV, for example with the aid of a hardware-based filter device HFE (FIG. 1), hardware-based filter device HFE including at least one associative memory, for example a content-addressable memory, for example a ternary content-addressable memory (TCAM). Optional block 122 according to FIG. 6 symbolizes an evaluation, e.g., similarly or identically to block 102 according to FIG. 1.

In further exemplary specific embodiments, FIG. 6, it is provided that the method includes: configuring 124 and/or reconfiguring filter rules FR, for example for the ascertainment of subset DV′, for example with the aid of filtering, for example, configuration 124 and/or reconfiguration of filter rules FR being repeated, for example periodically, and/or being carried out in an event-controlled manner.

In further exemplary specific embodiments, it is provided that configuration 124 and/or reconfiguration of filter rules FR is/are carried out dynamically, for example during the run time or during an operation of a device 200 carrying out the method (FIG. 12).

In further exemplary specific embodiments, it is provided that the data traffic which does not belong to subset DV′ is not evaluated and/or is disregarded during evaluation 102, 122.

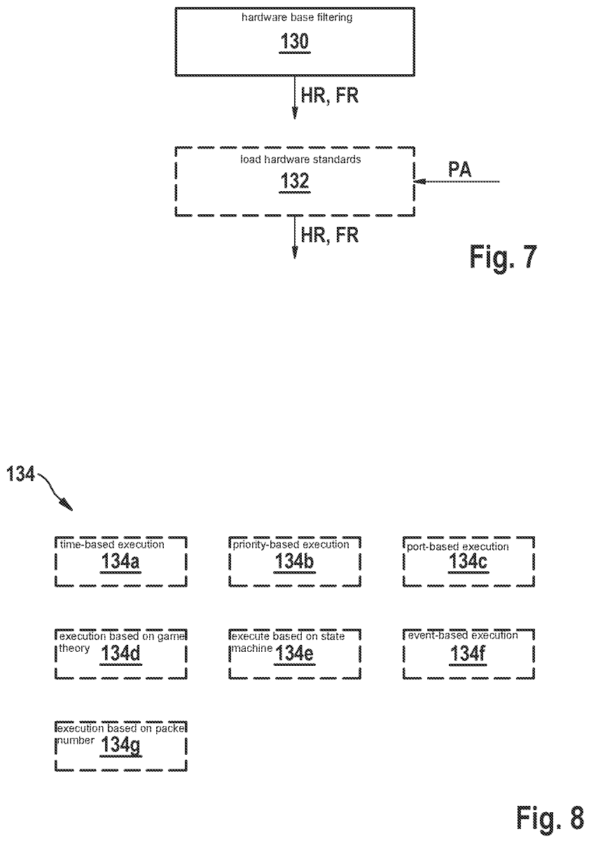

In further exemplary specific embodiments, FIG. 7, it is provided that the method includes: using 130 various hardware rule sets HR, for example filter rules FR, for example for a hardware-based filtering of data traffic DV (e.g., with the aid of TCAM), for example for ascertaining subset DV′, and, optionally, loading 132 various hardware rule sets HR, FR, for example according to a predefinable plan, for example characterizable by a predefinable planning algorithm PA, for example a scheduling algorithm.

In further exemplary specific embodiments, FIG. 8, it is provided that the method includes using 134 at least one of the following elements for planning algorithm PA: a) time-based execution 134a, for example loading, a next hardware rule set being loaded and/or used, for example, after a predefinable first time; b) priority-based execution 134b, a priority, for example, being assigned in each case to multiple rule sets, and, for example, a rule set having a higher priority being loaded and/or used more frequently than a rule set having a lower priority; c) port-based execution 134c, a certain rule set, for example, being active at a port of the network element at any point in time, the rule sets for the port being changed, for example, after a predefinable time; d) execution 134d based on a method according to the game theory, for example security games; e) execution 134e, for example loading, based on a state machine, sequences in the data traffic, for example, triggering a reconfiguration of a rule set; f) event-based execution 134f, for example, loading, the arrival of a predefinable packet of the data traffic, for example, triggering a reconfiguration of a rule set; and g) execution 134g, for example loading, based on a packet number, a rule set being changed, for example, following a predefinable number of, e.g., examined, packets.

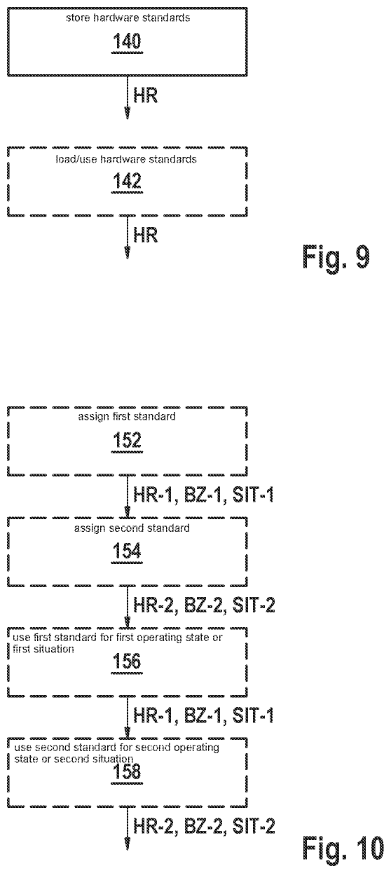

In further exemplary specific embodiments, FIG. 9, it is provided that the method includes: at least temporarily storing 140 various hardware rule sets HR or the various hardware rule sets HR, and, optionally, loading 142 and/or using at least one of various hardware rule sets HR, for example according to a or the planning algorithm PA (FIG. 7).

In further exemplary specific embodiments, FIG. 10, it is provided that the method includes at least one of the following elements: a) assigning 152 at least one first rule set HR-1 (including, for example, first filter rules, for example for a hardware-based filtering) to a first operating state BZ-1 or a first situation SIT-1, for example of a target system; b) assigning 154 at least one second rule set HR-2 (including, for example, second filter rules, for example for a hardware-based filtering) to a second operating state BZ-2 or a second situation SIT-2, for example of a or the target system; c) using 156 first rule set HR-1 for first operating state BZ-1 or first situation SIT-1; and d) using 158 second rule set HR-2 for second operating state BZ-2 or second situation SIT-2.

In further exemplary specific embodiments, it is provided that situation SIT, SIT-1, SIT-2 and/or operating state BZ-1, BZ-2 include(s) at least one of the following elements: a) diagnosis; b) update; c) energy mode, e.g., energy-saving mode, e.g., low power mode, e.g., sleep state; d) drive modes, e.g., forward, gear, backward, etc.; e) modes such as sports mode, ECO, comfort, emergency running, etc.; f) seasons; g) weather conditions; h) road conditions; i) presence of a trailer load, e.g., trailer attached; and j) smart phone connected.

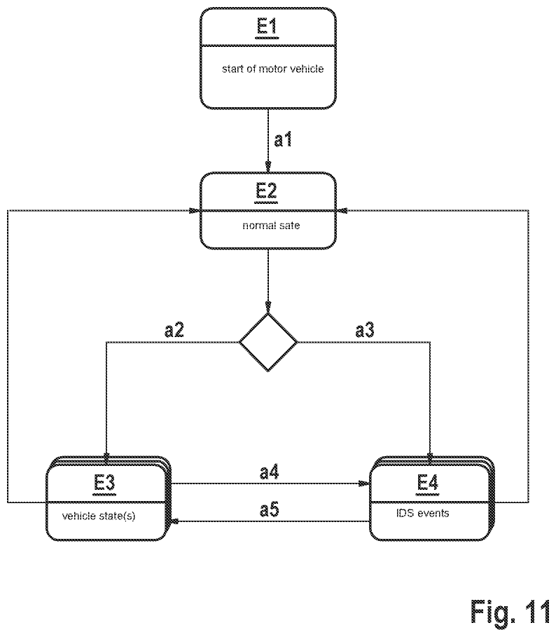

FIG. 11 schematically shows a simplified flowchart according to exemplary specific embodiments, the principle according to the specific embodiments being used in a switch 10 for a vehicle, e.g., a motor vehicle. Element E1, by way of example, symbolizes a start of the motor vehicle. Element E2, by way of example, symbolizes a normal operating state (“normal state”) to which a transition is made, proceeding from element E1, with the aid of arrow a1, e.g., as soon as the start is completed.

In further exemplary specific embodiments, it is provided that a comparatively specific analysis of data traffic DV or of a corresponding specific subset DV′ is carried out during start E1.

In further exemplary specific embodiments, it is provided that a comparatively comprehensive analysis of data traffic DV or of a corresponding specific subset DV′ is carried out during normal operation E2.

Element E3, by way of example, symbolizes a multitude of possible vehicle states, and element E4, by way of example, symbolizes a multitude of possible IDS events, i.e., events of an attack recognition system (IDS).

Arrow a2, by way of example, symbolizes a change from normal operation E2 to, e.g., one of multiple possible vehicle states, and arrow a3, by way of example, symbolizes a change from normal operation E2 to, e.g., one of multiple possible IDS events or states characterized thereby.

State transitions between elements E3, E4, as they may occur according to further exemplary specific embodiments, are symbolized by way of example by arrows a4, a5 in FIG. 11.

In further exemplary specific embodiments, a comparatively specific analysis of data traffic DV or of a comparatively specific subset DV′ of data traffic DV may be carried out, e.g., at least temporarily, which in further exemplary specific embodiments has the goal, e.g., of analyzing, for example as completely as possible, a data traffic relevant for the particular situation. In further exemplary specific embodiments, an analysis of the entire data traffic DV which is as complete as possible is, e.g., at least briefly negligible.

In further exemplary specific embodiments, e.g., at least one rule set and, e.g., maximally as many rule sets (e.g., specific rule sets) as are necessary for the analysis may be stored for a comparatively specific analysis, which are, for example selectively, usable in further exemplary specific embodiments.

In further exemplary specific embodiments, one or multiple of these rule sets may, for example, be used to analyze a data traffic, which, e.g., is exclusively relevant for the situation, or a corresponding subset DV′ of data traffic DV.

In further exemplary specific embodiments, one or multiple of these, e.g., comparatively specific rule sets may be loaded or used once, for example for the duration of the specific situation, and, for example, cannot be changed throughout this duration.

In further exemplary specific embodiments, various rule sets may be reloaded and/or used, for example dynamically, for example based on a predefinable planning algorithm PA (FIG. 7), for example when a set of rule sets for a specific analysis is more comprehensive and/or more complex.

In further exemplary specific embodiments, a change between, e.g., a comprehensive and, e.g., a specific analysis of at least a subset DV′ of the data traffic may, e.g., take place as follows, cf. FIG. 11: When starting E1 the vehicle, e.g., the communication of control units 11a, 11b, 11c (FIG. 1) differs from the communication in a normal operating situation (normal state or normal operation) E2. In this situation (starting E1), an, e.g., comparatively specific analysis is thus used in further exemplary specific embodiments. When starting E1 is completed, a (filter or rule) configuration, e.g., for normal behavior or normal operation E2, is loaded in further exemplary specific embodiments.

In further exemplary specific embodiments, the attention in normal operating situations E2 of the vehicle is turned e.g., to a preferably comprehensive analysis of the data traffic. In this situation E2, in further exemplary specific embodiments, the possibly comparatively comprehensive rule sets for starting E1 are thus, e.g., regularly, re-loaded, e.g., by a selected scheduling algorithm PA (FIG. 7). Based on various situations, it may be useful in further exemplary specific embodiments to switch from the comprehensive network analysis mode according to block E2 into an, e.g., more specific mode, for example according to elements E3, E4.

In further exemplary specific embodiments, situations in which such a change may be useful are, e.g., various vehicle states, such as for example: update, low power mode (sleep), drive modes (forward, gear, backward, etc.), modes (sports, ECO, comfort, emergency running, etc.), seasons/weather conditions, road conditions, trailer attached, or smart phone connected.

In further exemplary specific embodiments, an, e.g., further possible, reason for the loading or use of specific rule sets HR may be recognized/reported IDS events E4. If, according to further exemplary specific embodiments, an anomaly is established, e.g., during an IDS, it may be useful to specifically examine the data traffic affected by the anomaly. When, for example in further exemplary specific embodiments, an anomaly is recognized with a transport control protocol (TCP), it may be useful in further exemplary specific embodiments to at least temporarily examine the TCP data traffic more closely, e.g., in the near future.

When, in further exemplary specific embodiments, the vehicle state, e.g., switches into the normal state again and/or no further IDS anomaly has occurred for a certain time, in further exemplary specific embodiments the IDS also switches into the normal state again, and thus, e.g., into the comprehensive network analysis or comprehensive analysis of data traffic DV or a comparatively comprehensive subset DV′ of data traffic DV.

If, in further exemplary specific embodiments, the IDS is, e.g., in a state specific to the vehicle state and an IDS event occurs, it may be useful in further exemplary specific embodiments to combine the two specific rule sets with one another.

If, in further exemplary specific embodiments, the IDS is in an IDS event-specific state, and the vehicle transitions into a different vehicle state, cf. arrow a5 according to FIG. 11, it may also be useful in this case, in further exemplary specific embodiments, to combine the two specific rule sets.

In further exemplary specific embodiments, it may furthermore be provided that the previously IDS-specific rule set no longer plays a role in the new state of the vehicle, and the vehicle-specific state accordingly “overwrites” the IDS-specific state.

Further exemplary specific embodiments, FIG. 12, relate to a device 200 for carrying out the method according to the specific embodiments.

In further exemplary specific embodiments, it is provided that device 200 includes: a computing unit (“computer”) 202 including, e.g., at least one computing core 202a, 202b, 202c, a memory unit 204 assigned to computing unit 202 for at least temporarily storing at least one of the following elements: a) data DAT; and b) computer program PRG, in particular, for carrying out the method according to the specific embodiments.

In further exemplary specific embodiments, data DAT may at least temporarily include subset DV′ of data traffic DV and/or data derivable therefrom, for example with the aid of evaluation 102, 122.

In further exemplary specific embodiments, memory unit 204 includes a volatile memory 204a (e.g., a working memory (RAM)), and/or a non-volatile memory 204b (e.g., a Flash EEPROM), or a combination thereof or with other, not explicitly described memory types.

Further exemplary specific embodiments relate to a computer-readable memory medium SM, encompassing commands PRG, which, during the execution by a computer 202, prompt the computer to carry out the method according to the specific embodiments.

Further exemplary specific embodiments relate to a computer program PRG, encompassing commands which, during the execution of program PRG by a computer 202, prompt the computer to carry out the method according to the specific embodiments.

Further exemplary specific embodiments relate to a data medium signal DCS which transfers and/or characterizes computer program PRG according to the specific embodiments. For example, data medium signal DCS is transferrable via an optional data interface 206.

In further exemplary specific embodiments, device 200 according to FIG. 12 may, e.g., be integrated into switch 10 (FIG. 1), or a computing unit (not shown) of switch 10 may be designed to at least temporarily carry out at least individual aspects of the method according to the specific embodiments.

In further exemplary specific embodiments, the principle according to the specific embodiments may, e.g., be used to carry out a comprehensive analysis of the network traffic, e.g., with the goal of achieving a greatest possible coverage of the analyzed network traffic, e.g., without analyzing the entire network traffic DV.

In further exemplary specific embodiments, a situation-dependent reconfiguration may take place, e.g., with the goal of analyzing network traffic DV as comprehensively or as specifically as possible.

During the comprehensive analysis of the network traffic according to further exemplary specific embodiments, e.g., preferably many different parts of the network traffic are to be analyzed, e.g., to achieve a greatest possible coverage of the network traffic, e.g., without analyzing the entire network traffic in the process.

During the specific analysis of the network traffic according to further exemplary specific embodiments, e.g., as much as possible is to be analyzed of network traffic relevant for situation SIT. This network traffic is a specifiable portion DV′ of the entire network traffic DV. The remaining network traffic, e.g., plays a minor role in this situation and is not analyzed in further exemplary specific embodiments.

Further exemplary specific embodiments, FIG. 13, relate to a use 300 of the method according to the specific embodiments and/or of device 200 according to the specific embodiments and/or of computer-readable memory medium SM according to the specific embodiments and/or of computer program PRG according to the specific embodiments and/or of data medium signal DCS according to the specific embodiments for at least one of the following elements: a) ascertaining 302 a subset DV′ of a data traffic DV associated with network element 10, for example of a motor vehicle; b) evaluating 304 a subset DV′ of a data traffic DV associated with network element 10, for example of a motor vehicle; c) implementing 306 a, for example network-based, attack recognition system (NIDS), for example for a motor vehicle, for example on a computing unit 202 (FIG. 12) of a switch 10 (FIG. 1), for example an automotive switch; d) taking into consideration 308 a portion DV′ of data traffic DV associated with a situation SIT and/or an operating state BZ-1, BZ-2; and e) configuring 310 and/or reconfiguring, as a function of the situation, at least one aspect of a device 200 carrying out the method, for example filter rules FR and/or rule sets HR, for example hardware rule sets HR.

1-18. (canceled)

19. A computer-implemented method for processing data associated with a first network element, the method comprising:
ascertaining a subset of a data traffic associated with the network element; and
evaluating the subset.

20. The method as recited in claim 19, wherein the first network element is configured to couple multiple further network elements, the first network element being a switch.

21. The method as recited in claim 19, wherein the ascertaining of the subset includes:
selecting the subset based on a situation, the situation being characterizable and/or characterized by at least one of the following elements:
a) a state of a target system,
b) a state of an attack recognition system, based on at least one present event of the attack recognition system, and/or based on a recognition of anomalies;
c) a state of a communication between sub-systems, at least one of the sub-systems including a control unit or a sub-network of a network,
d) a state of surroundings,
e) a state of at least one sub-system of a vehicle.

22. The method as recited in claim 21, further comprising at at least one of the following steps:
a) ascertaining the situation and/or at least one of the states based on the data traffic,
b) receiving first pieces of information characterizing the situation and/or the at least one state from at least one further unit.

23. The method as recited in claim 19, further comprising:
filtering the data traffic using a hardware-based filter device, the hardware-based filter device including at least one associative memory including a content-addressable memory.

24. The method as recited in claim 19, further comprising:
configuring and/or reconfiguring filter rules for the ascertaining of the subset, the configuration and/or reconfiguration of the filter rules being repeated, periodically, and/or being carried out in an event-controlled manner.

25. The method as recited in claim 24, wherein the configuration and/or reconfiguration of the filter rules is carried out dynamically during run time or during an operation of a device carrying out the method.

26. The method as recited in claim 19, wherein those of the data traffic which does not belong to the subset are not evaluated and/or are disregarded during the evaluation.

27. The method as recited in claim 19, further comprising:
using various hardware filter rule sets for a hardware-based filtering of the data traffic for ascertaining the subset, and loading the various hardware filter rule sets according to a predefinable plan characterized by a predefinable planning algorithm.

28. The method as recited in claim 27, further comprising:
using at least one of the following elements for the planning algorithm:
a) time-based loading, a next hardware rule set being loaded and/or used after a predefinable first time;
b) priority-based loading, a priority being assigned to each of multiple rule sets, and, a rule set having a higher priority being loaded and/or used more frequently than a rule set having a lower priority;
c) port-based loading, a certain rule set, for example, being active at a port of the network element at any point in time, rule sets for the port being changed after a predefinable time;
d) loading according to game theory;
e) loading, based on a state machine, sequences in the data traffic triggering a reconfiguration of a rule set;
f) event-based loading, arrival of a predefinable packet of the data traffic triggering a reconfiguration of a rule set;
g) loading based on a packet number, a rule set being changed following a predefinable number of examined, packets.

29. The method as recited in claim 19, further comprising:
at least temporarily storing various hardware rule sets, and loading and/or using at least one of the various hardware rule sets according to a planning algorithm.

30. The method as recited in claim 19, further comprising at least one of the following steps:
a) assigning at least one first rule set to a first operating state or a first situation of a target system;
b) assigning at least one second rule set to a second operating state or a second situation of the target system;
c) using the first rule set for the first operating state or the first situation;
d) using the second rule set for the second operating state or the second situation.

31. The method as recited in claim 30, wherein the situation and/or the operating state includes at least one of the following elements: a) diagnosis; b) update; c) energy-saving mode; d) a drive mode; e) a modes including a sports mode, an ECO, mode, a comfort mode, an emergency running; f) a season; g) a weather condition; h) a road condition; i) presence of a trailer load; j) smart phone connected.

32. A device configured to process data associated with a first network element, the device configured to:
ascertain a subset of a data traffic associated with the network element; and
evaluate the subset.

33. A non-transitory computer-readable memory medium on which is stored a computer program including commands for processing data associated with a first network element, the commands, when executed by a computer, causing the computer to perform the following steps:
ascertaining a subset of a data traffic associated with the network element; and
evaluating the subset.

34. The method as recited in claim 19, wherein the method is used for at least one of the following:
a) ascertaining a subset of a data traffic associated with the network element of a motor vehicle;
b) evaluating a subset of a data traffic associated with the network element of a motor vehicle;
c) implementing a network-based, attack recognition system for a motor vehicle, on a computing unit of an automotive switch;
d) taking into consideration a portion of the data traffic associated with a situation and/or an operating state;
e) configuring or reconfiguring, as a function of the situation, at least one aspect of a device carrying out the method, filter rules and/or hardware rule sets.
